(19) United States
(12) Patent Application Publication
(10) Pub. No.: US 2014/0080039 A1
(43) Pub. Date: Mar. 20, 2014

(54) SULFONATED SILICA-BASED ELECTRODE MATERIALS USEFUL IN FUEL CELLS

(71) Applicant: University of Ontario Institute of Technology, Oshawa (CA)

(72) Inventors: E. Bradley Easton, Oshawa (CA); Jennie I. Eastcott, Oshawa (CA)

(73) Assignee: University of Ontario Institute of Technology, Oshawa (CA)

(21) Appl. No.: 14/026,763

(22) Filed: Sep. 13, 2013

Related U.S. Application Data
(60) Provisional application No. 61/701,225, filed on Sep. 14, 2012.

(51) Int. Cl. H01M 4/86; H01M 4/88

(52) U.S. Cl. CPC H01M 4/8652; H01M 4/8825
USPC 429/530; 502/101

(57) ABSTRACT

Sulfonated silane ionomeric materials useful in electrodes of e.g., membrane electrode assemblies (MEA) of fuel cells can improve cell performance. MEAs prepared with CCE cathode catalyst layers and standard ELAT anode layers over a period of several start-stop cycles, as well as at multiple relative humidities were studied. The MEA performance was monitored using cyclic voltammetry, electrochemical impedance spectroscopy, and fuel cell polarization curves. The CCE cathode materials appeared to maintain performance and had improved water management capabilities at comparatively low relative humidities.

### RELATED APPLICATION

This application claims the benefit of U.S. Provisional Patent Application Ser. No. 61/701,225 filed Sep. 14, 2012, which is incorporated by reference herein.

### FIELD OF THE INVENTION

The present invention relates to electrodes for fuel cell devices, particularly to electrode composite material containing an ionomer.

### BACKGROUND OF THE INVENTION

Proton exchange membrane fuel cells (PEMFCs) are a technology with the potential to help meet both current and future energy needs. The heart of a PEM fuel cell is the membrane electrode assembly (MEA) which has two electrodes (anode and cathode) separated by a proton exchange membrane. Typical commercial catalyst layers contain a carbon-supported platinum catalyst combined with Nafion® ionomer¹. The addition of ionomer acts as a binder for the carbon support and imparts proton conductivity to the catalyst layer which increases catalyst utilization². While commercial ionomers are efficient proton conductors, they suffer from several shortcomings such as high cost³, restriction of gas pores⁴, and poor performance in low water environments i.e., low relative humidity and higher temperatures⁵. Efforts to improve performance have included efforts to reduce Nafion® content by surface modification of the carbon support^{4, 6-12}. Hydrocarbon-based ionomers such as sulfonated poly(ether ether ketone) (SPEEK)^{3, 13-17}, sulfonated polyphosphazene¹⁸, and polysulfones¹⁹ have been investigated as replacements for Nafion® but each one has its own unique set of challenges.

Another approach to improving catalyst layer performance is modification of the electrode structure. Ceramic carbon electrodes (CCEs) are promising candidates for fuel cell electrodes in this regard. The tuneable nature of CCEs makes them suitable candidates for use in a number of areas such as fuel cells²⁰⁻²², sensors, lithium ion batteries, and super capacitors^{23, 24}. CCEs are comprised of electronically conductive carbon particles bound by a ceramic binder prepared via the sol-gel process to produce a gel formed from colloidal suspensions²⁵. The method of synthesis allows for variation of numerous conditions (e.g. pH, solvent, concentration) to modify material properties, including microstructure.

### SUMMARY OF THE INVENTION

In one aspect, the invention is a method of making a composite electrode catalyst layer. The method comprises:

(i) forming a sol-gel by at least partially polymerizing first and second precursors of an ionomer, the first precursor being a sulfonated organosilane, in the presence of a carbon-supported catalyst; and

(ii) applying the sol-gel to a substrate.

The term “sol-gel” refers to a composition, such as the composition described below in exemplifying the invention. Such composition is made up of a carbon-supported catalyst and polymer precursors interpenetrated with each other, which composition undergoes a phase transition over time, as the precursors polymerize, or at least partially polymerize, from a flowable composition to a gel or partial gel. As a gel or partial gel, the composition is suitable for deposition as by spray deposition onto a substrate. A drying process may remove the liquid phase from the gel, forming a porous material.

An “ionomer” is a polymer, as known in the art, in which at least one of the monomeric precursors from which it is formed, comprises group(s) that can dissociate in aqueous solutions, making the polymer charged, such as polysulfonated polymers described herein. At least one of the other monomeric units of an ionomer is uncharged.

In an aspect, the sulfonated organosilane has the structure shown by formula (I):

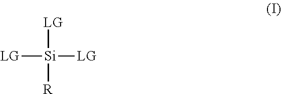

wherein:

R is sulfanylalkyl, sulfanylaryl, sulfanylalkylaryl, sulfanylarylalkyl or sulfanylalkylarylalkyl; and

each LG is a leaving group.

The term “leaving group” means an atom or group that becomes detached from an atom in what is considered to be the residual or main part of the molecule taking part in a specified reaction. As exemplified herein, an ethoxy group of a Si-LG moiety can act as a leaving group during polymerization ionomer precursors

Each leaving group can be, for example, alkoxy, Cl, Br, hydroxy, aryloxy, arylalkoxy or alkylaryloxy and they can be the same or different from each other.

Preferably at least one LG of formula (I) is hydroxyl, two or all three may be hydroxy. In the illustrative embodiment, all three LGs are hydroxyl groups.

“Alkyl” is a hydrocarbon structure having 1 to 20 carbon atoms, preferably 1 to 12 carbon atoms and more preferably 1 to 8 carbon atoms, 1 to 6, 1 to 4 or 1 to 3 carbon atoms. The term includes branched or cyclic hydrocarbon structures having 3 to 20 carbon atoms, preferably 3 to 12 carbon atoms and more preferably 3 to 8 carbon atoms, or 3 to 6 carbon atoms. Examples of alkyl groups include methyl, ethyl, n-propyl, i-propyl, t-butyl, n-heptyl, octyl, cyclopentyl, cyclopropyl, cyclobutyl, norbornyl, and the like.

“Alkenyl” refers to a hydrocarbon group of two or more carbon atoms, such as 2 to 10 carbon atoms and more preferably 2 to 6 carbon atoms, 2 to 4 or 2 to 3 carbon atoms, and corresponds to an alkyl group having at least 1 and preferably from 1 or 2 sites of alkenyl unsaturation. Examples of an alkenyl group include —C═CH₂, —CH₂CH═CHCH₃ and —CH₂CH═CHCH═CH₂.

The term “aryl” indicates a radical of aromatic carbocyclic rings having 6 to 20 carbon atoms, or 6 to 14 carbon atoms, preferably 6 to 10 carbon atoms, in particular 6-membered rings, optionally fused carbocyclic rings with at least one aromatic ring, such as phenyl, naphthyl, indenyl and indanyl.

“Alkoxy” refers to an alkyl group that is connected to the parent structure through an oxygen atom (—O-alkyl). Examples include methoxy, ethoxy, propoxy, isopropoxy, cyclopropyloxy, cyclohexyloxy and the like.

Likewise, “aryloxy” refers to an aryl group that is connected to the parent structure through an oxygen atom (—O-aryl), which by way of example includes the residues phenoxy, naphthoxy, and the like.

Substituted alkoxy or substituted aryloxy refers to a substituted alkyl or aryl group connected to the parent structure through an oxygen atom (—O-substituted aryl).

Alkyl, aryl groups, etc. are optionally substituted. In an exemplifying embodiment, the R group of formula (I) is an alkylsulfanyl in which the alkyl group is propyl. A “sulfonated” group is one having a sulfonate (—SO₃H) substituent and such designation is made without regard to the protonation state of the substituent.

Any suitable catalyst may be used in the practice of the present disclosure. Typically, carbon-supported catalyst particles are used. Typical carbon-supported catalyst particles are 50-90% carbon and 10-50% catalyst metal by weight, the catalyst metal typically comprising platinum (Pt), but other catalysts may be carbon-supported e.g., one or more of platinum, ruthenium, cobalt, nickel, iron, manganese and irdium.

Preferably, the first and second precursors are selected such that a sulfonated silica ionomer is formed during polymerization.

In an aspect, the second precursor has the structure shown by formula (II):

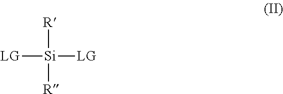

wherein:

each LG is a leaving group; and

each of R′ and R″ is, independently of the other, a leaving group or optionally substituted alkyl, optionally substituted alkenyl, optionally substituted aryl, optionally substituted arylalkyl, optionally substituted alkylaryl, wherein the optional substituents are independently selected from the group consisting of F (fluorine), hydroxy (—OH) and methyl (—CH₃).

Each leaving group can be, for example, alkoxy, Cl, Br, hydroxy, aryloxy, arylalkoxy, or alkylaryloxy, and can be the same or different as the others. One or the other or both of R′ and R″ can be a leaving group.

In the exemplifying embodiment, all four substituents of the Si atom of the second precursor of formula (II) is ethoxy.

In an aspect, foregoing step (i) can include forming a mixture of the first and second precursors and the carbon-supported catalyst in the presence of water in a base which catalyzes polymerization of the precursors. In the illustrative embodiment, the mixture also includes the lower alcohol that is methanol. A “lower alcohol” is alkane in which one the hydrogens has been replaced by a hydroxyl group, the alkyl portion of the molecule having from 1 to 5 carbons. In the illustrative embodiment, the base is ammonium hydroxide.

In the case of making a composite electrode catalyst layer bound to a substrate, the sol-gel is dried after being applied to the substrate to remove solvent therefrom. The step of drying is selected to be suitable under the circumstances, and can be at least 100° C., or at least 110° C., or at least 120° C., or at least 130° C., or at least 135° C., or about 100° C., or about 110° C., or about 120° C., or about 130° C., or about 135° C., as in the illustrative embodiment.

Preferably, forming the sol-gel includes mixing the first and second precursors and carbon-supported catalyst such that the carbon-supported catalyst becomes embedded in the matrix of the ionomer during the at least partially polymerizing step, and so is embedded in the matrix in the finished catalyst layer.

In preferred embodiments, the sol-gel is spray deposited onto the substrate.

In another aspect, the invention is a method of forming a catalyst layer of a composite electrode, comprising: coating a substrate with a sol-gel composition comprising the reaction product of first and second precursors of an ionomer, the first precursor being a sulfonated organosilane, and a carbon-supported catalyst; and drying the coated substrate to remove solvent of the composition and form the catalyst layer.

In synthetic methods of the invention, relative amounts of the precursors are selected to obtain a desired degree of sulfonation of the iononomer. For example, relative amounts of the first and second precursors are selected to obtain an ionomer in which the ratio of sulfonated:unsulfonated polymer units is between 0.01 and 0.99, or between 0.01 and 0.5, or 0.01 and 0.4, or 0.01 and 0.3, and 0.01 and 0.2, or 0.02 and 0.4, or 0.02 and 0.3, or 0.02 and 0.2, or 0.02 and 0.1, or 0.03 and 0.4, or 0.03 and 0.3, or 0.03 and 0.2, or 0.03 and 0.1, or 0.03 and 0.09, or 0.04 and 0.3, or 0.04 and 0.2, or 0.04 and 0.1, or 0.04 and 0.09, or 0.04 and 0.08, or 0.05 and 0.2, or 0.05 and 0.15, or 0.05 and 0.1, or 0.05 and 0.09, or 0.05 and 0.8, or 0.05 and 0.07, or the ratio of sulfonated:unsulfonated polymer units is about 0.01, about 0.02, about 0.03, about 0.04, about 0.05, about 0.06, about 0.07, about 0.08, about 0.09, about 0.1, about 0.11, about 0.12, about 0.13, about 0.14, or about 0.15. In an illustrative embodiment, a molar ratio of TPS:TEOS (3-trihydroxylsilyl-1-propane sulfonic acid:tetraethyl orthosilicate) of 5:95 was used.

In the case of a hydrogen fuel cell, the catalyst material forms a layer secured to a proton exchange membrane. In embodiments, the catalyst material is spray deposited onto a microporous layer comprising PTFE/carbon black and carbon fiber.

A PEM can include known materials such as Nafion®, sulfonated hydrocarbon-based membranes including sulfonated poly(ether ether ketone) (SPEEK), composite containing one or more inorganic components, including Nafion/SiO₂, SPEEK/SiO₂, and sulfonated siloxanes comprising the structure of formula (A):

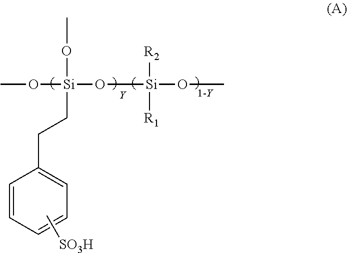

wherein R₁ and R₂ are substituent groups, and 0≦Y≦1. These latter materials are described in United States Patent Publication No. 2011/0098370 published Apr. 28, 2011 (Easton et al.), the entire specification of which is incorporated herein by reference as though reproduced herein in its entirety.

A microporous layer can comprise, for example, carbon black mixed with a fluoropolymer, including polytetrafluoroethylene (PTFE).

The substrate can include a gas diffusion layer directly bonded to the microporous layer.

A composite material of the invention can include an ionomer and carbon-supported catalyst, wherein the carbon-supported catalyst is embedded in the matrix of the ionomer and the ionomer comprises the reaction product of a sulfonated organosilane and a silica precursor.

In embodiments, the ionomer is the reaction product of a sulfonated organosilane having the structure shown by formula (I):

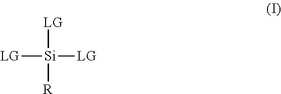

wherein:

R is sulfanylalkyl, sulfanylaryl, sulfanylalkylaryl, sulfanylarylalkyl or sulfanylalkylarylalkyl; and

each LG is a leaving group; and

the silica precursor having the structure shown by formula (II):

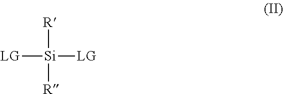

wherein:

each LG is a leaving group; and

each of R′ and R″ is, independently of the other, a leaving group or optionally substituted alkyl, optionally substituted alkenyl, optionally substituted aryl, optionally substituted arylalkyl, optionally substituted alkylaryl, wherein the optional substituents are independently selected from the group consisting of F, hydroxyl and methyl.

The ionomer can include the structure shown by formula (III):

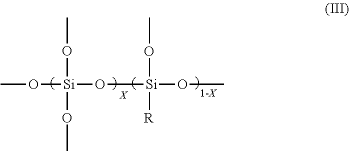

wherein R is sulfanylalkyl, sulfanylaryl, sulfanylalkylaryl, sulfanylarylalkyl or sulfanylalkylarylalkyl. The value of X is between 0 and 1 and the ratio of (1−X)/X is between 0.01 and 0.99, or between 0.01 and 0.5, or 0.01 and 0.4, or 0.01 and 0.3, and 0.01 and 0.2, or 0.02 and 0.4, or 0.02 and 0.3, or 0.02 and 0.2, or 0.02 and 0.1, or 0.03 and 0.4, or 0.03 and 0.3, or 0.03 and 0.2, or 0.03 and 0.1, or 0.03 and 0.09, or 0.04 and 0.3, or 0.04 and 0.2, or 0.04 and 0.1, or 0.04 and 0.09, or 0.04 and 0.08, or 0.05 and 0.2, or 0.05 and 0.15, or 0.05 and 0.1, or 0.05 and 0.09, or 0.05 and 0.8, or 0.05 and 0.07, or (1−X)/X is about 0.01, about 0.02, about 0.03, about 0.04, about 0.05, about 0.06, about 0.07, about 0.08, about 0.09, about 0.1, about 0.11, about 0.12, about 0.13, about 0.14, or about 0.15. A preferred ratio is about 0.06.

In formula (III), R can be one or more of:

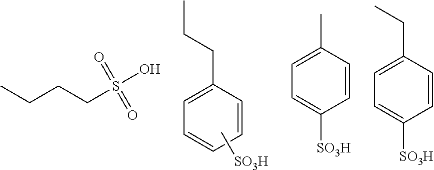

In an illustrative embodiment, R is —CH₂CH₂CH₂SO₃H.

Each of R′ and R″ can be selected, independently of the other, from the group consisting of methyl, ethyl, vinyl (H₂C═CH—), propyl, CF₃CH₂CH₂—, PhCH₂CH₂— (Ph=phenyl), benzyl, and phenyl.

It is possible for the catalyst composite material to be prepared without Nafion® so that the product obtained is substantially free of Nafion®.

According to an embodiment, the invention is a composite material comprising:

an ionomer; and

a carbon-supported catalyst embedded in the matrix of the ionomer,

wherein:

the ionomer comprises the structure shown by formula (III):

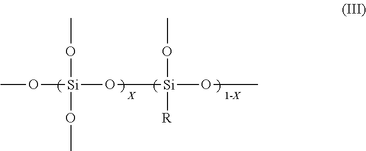

wherein:

R is sulfanylalkyl, sulfanylaryl, sulfanylalkylaryl, sulfanylarylalkyl or sulfanylalkylarylalkyl; and

0≦X≦1 and (1−X)/X is between 0.01 and 0.99.

The invention also includes a membrane electrode assembly comprising an electrode and a polymer electrolyte membrane wherein the electrode comprises a composite material described herein.

In embodiments, the invention includes a fuel cell, a sensor, a lithium ion battery or a super capacitor comprising an electrode wherein the electrode comprises a composite material described herein.

Organosilane precursors have hygroscopic properties that allow for water retention. The ability to retain water is important for MEA function under high temperatures, such as over 100° C., and low relative humidity conditions. Nafion® has optimal performance when fully hydrated, so effort must be taken to ensure the gases entering the cell have been humidified. This limits the uses of Nafion® to applications in which liquid water is abundant⁵. Earlier research had demonstrated that introduction of the hydrophilic SiO₂ backbone affects the proton conductivity of CCEs without the addition of a functionalized side chain²¹. The results obtained through the invention and described further below, indicate that the hygroscopic properties of the chosen organosilane materials not only ensure hydration of the catalyst layer in use, but possibly of an associated membrane as well, via back-diffusion.

### BRIEF DESCRIPTION OF THE DRAWINGS

Embodiments of the present invention are described in greater detail with reference to the accompanying drawings, in which:

FIG. 1 shows (a) examples of sulfonated organolsilane precursors (1-4) and non-sulfonated organosilane precursors (5-14) that can be used to for ion conducting silicate-based polymers for use in CCEs, and (b) chemical structures of the ion conducting silica-based co-polymer that can be employed in the CCE catalyst layer.

FIG. 2 is a schematic representation of the synthesis and concurrent deposition of the CCE catalyst layer to form fuel cell electrodes.²⁶

FIG. 3 shows SEM images obtained for CCE-based catalyst layers at (a) lower and (b) high magnification.²⁶

FIG. 4 shows BET surface area analysis obtained for composite TPS/TEOS CCEs.²⁸

FIG. 5 shows half-cell CVs obtained for CCE catalyst layers of various TPS/TEOS loadings. A Pt loading of 0.15 mg cm⁻² was used in all cases.²⁸

FIG. 6 shows Nyquist plots obtained for TPS/TEOS catalyst layers (half-cell) with various silicate loadings (TPS:TEOS). Control data (Pt/C+Nafion® standard, TEOS control) are shown as solid symbols; open symbols are sulfonated CCEs.²⁸

FIG. 7 shows capacitance plots obtained for TPS/TEOS catalyst layers (half-cell) with various silicate loadings (TPS:TEOS). Control (Pt/C+Nafion®, TEOS control) are shown as solid symbols; open symbols are sulfonated CCEs.²⁸

FIG. 8 shows trends in ECSA and limiting capacitance for TPS/TEOS composite CCEs.²⁸

FIG. 9 is a comparison of fuel cell CV obtained for SS-CCE catalyst layer with that obtained with a Nafion®-based ELAT cathode catalyst layer (a) as acquired and (b) normalized to the Pt loading in each electrode. Measurements were made at 30° C. with an N₂-purged cathode compartment at 100% RH.²⁶

FIG. 10 is a comparison of fuel cell EIS responses obtained for the SS—CCE cathode catalyst layer with that obtained with a Nafion®-based ELAT cathode catalyst layer plotted as (a) capacitance plots and (b) normalized capacitance plots and (c) Nyquist plots. Measurements were made at 30° C. with an N₂-purged cathode compartment at 100% RH.²⁶

FIG. 11 is an expansion of the high frequency regions of FIG. 9.²⁶

FIG. 12 is a comparison of the H₂/O₂ fuel cell polarization curves obtained for the SS-CCE cathode catalyst layers with that obtained with a Nafion-based ELAT cathode catalyst layer. Measurements were made at 80° C. at 100% RH with 10 psig back pressure on both gas feeds.²⁶FIG. 13 shows Nyquist plots of fuel cell EIS data for a) ELAT cathode and b) SS-CCE cathode at 80° C. obtained for multiple relative humidities.

FIG. 14 shows capacitance plots of fuel cell EIS data from a) ELAT cathode and b) SS-CCE cathode at 80° C. obtained over multiple relative humidities.

FIG. 15 shows membrane resistance as a function of relative humidity for SS-CCE cathode and ELAT cathode at 80° C.

FIG. 16(a) is a comparison of the H₂/O₂ fuel cell polarization curves obtained for the SS-CCE cathode catalyst layers at multiple relative humidities with that obtained with a Nafion-based ELAT cathode catalyst layer at 100% RH; and (b) shows variation in cell potential at 1 A mg_{Pt}⁻¹ for ELAT and SS-CCE cathode catalyst layers. Measurements were made with 10 psig back pressure on both gas feeds.

FIG. 17 is a schematic representation showing the location of water retention agent in (a) a conventional design where it is located in the membrane and (b) according to the invention, where the water retention agent is located in the electrode structures.

### DETAILED DESCRIPTION OF THE INVENTION

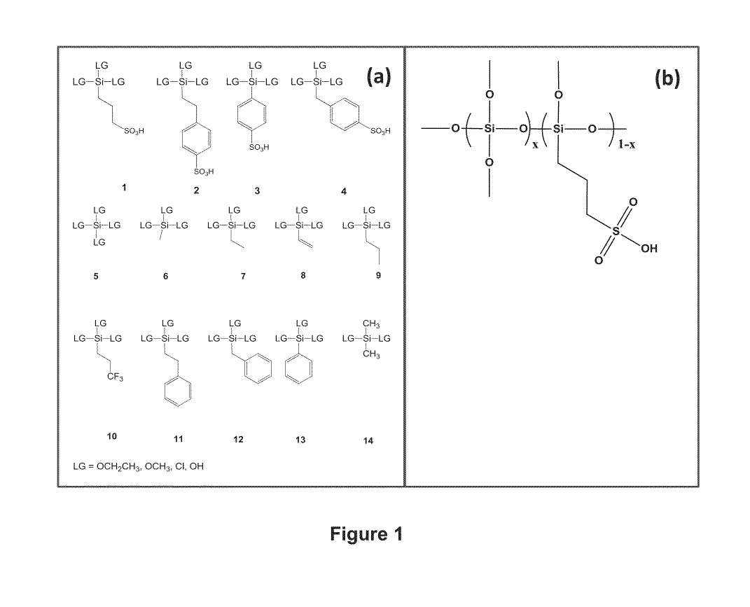

Water is necessary to facilitate good proton conduction in a MEA, and sulfonate groups are known to aid proton conduction. Organosilane precursors with side chains containing sulfonate groups were used in hope of increasing the proton conducting nature of CCEs of the invention. A portion of the chemical structure of an ionomer organosilcate polymer tested is shown in FIG. 1. Here, a CCE fabrication method is described in which the ionomer precursors are added in monomer form to carbon and subsequently polymerized²⁶. The polymerization of the precursors in situ provides an opportunity for the organosilane to chemically bond to e.g., hydroxyl groups on the carbon surface to permit proton transport to the active catalyst surface. One aspect of this work is the growth of the monomers into a polymer network around the carbon-supported catalyst to result in a composite material in which the carbon-supported catalyst is embedded in matrix of an ionomer. The silicate (SiO₂) network may act to protect the carbon support from degradation over prolonged use in a corrosive fuel cell environment, while the porosity facilitates enhanced three-phase boundaries to promote gas and water transport to and from active sites. The test results presented demonstrate that, when sulfonated silica-based electrode structures are used at the cathode, similar performance to state-of-the-art Nafion®-based cathodes can be achieved with gases that are fully humidified (100% relative humidity) as well as under relatively low RH conditions. Nafion®-based electrodes require hydration to ensure optimal performance²⁷, meaning that sulfonated silica-based electrodes described herein are more versatile because of the capacity to operate at low RH. A common approach to water retention under high temperature/low RH conditions has been to modify the Nafion® membrane to increase its hygroscopicity and extend its operational range, or to use a different membrane material that may be able to operate under more extreme conditions. The hygroscopic nature of the silicate material in the electrodes described herein provides a means of water retention within the MEA. Water retention in the catalyst layer may provide a source of hydration for the PEM at low RH via back diffusion of water, while ensuring flooding of the membrane pores at higher RH is minimal.

Also described herein is fabrication of materials which are suitable for incorporation into e.g., fuel cell applications. CCE can gel into a monolith dried, ground into a fine powder, suspended in solution, and sprayed onto the GDL. Herein is described a procedure in which partially gelled CCE material is spray deposited directly onto a gas diffusion layer (GDL), provided the GDL was first coated with a microporous layer (MPL). The addition of the MPL improve adhesion of the CCE layer to the MPL as the MPL provides a rougher surface in which the water-containing gel could deposit on the hydrophobic GDL/MPL surface. It is thus expected that the CCE material can be similarly spray applied directly onto a PEM to form a catalyst coated membrane (CCM).

The following examples provide an overview of sulfonated CCE electrodes prepared using 3-trihydroxysilyl-1-propanesulfonic acid (TPS) and tetraethyl orthosilicate (TEOS) ionomer precursors. Optimization of concentrations and fabrication techniques are outlined, as well as the electrochemical fuel cell performance of CCE materials in comparison standard Nafion®-containing electrodes under both fully hydrated and low humidity conditions.

Generally speaking, the invention described herein is directed to a composition and synthesis of sulfonated silica-based electrode structures that can be used with e.g., proton exchange membranes of fuel cells. This offers the possibility of PEM fuel cells that can operate under high temperature/low humidification conditions, hygroscopic agents being located in catalyst layer(s), as opposed to the membrane.

As required, embodiments of the present invention are disclosed herein. However, the disclosed embodiments are merely exemplary, and it should be understood that the method may be embodied in many various and alternative forms. The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to the synthesis of CCE from a mixture of Tetraethylorthosilicate (TEOS, Sigma) and 3-(trihydroxysilyl)-1-propanesulfonic acid. Some exemplary, non-limiting examples of non-sulfonated organosilane precursors are shown in FIG. 1.

A number of embodiments of the present invention are possible for differing applications. The following description is illustrative of one embodiment and is not meant to be limiting.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

CCE Monolith Preparation

CCE materials were prepared to evaluate different sulfonate concentrations via the sol-gel method as published²⁸. Dry 20% platinum on Vulcan XC72 carbon black (ETEK) was weighted in a clean, dry 50 mL glass beaker. Deionized water (Type 1) was first added to the beaker to prevent platinum ignition upon subsequent addition of methanol. The water and carbon-supported catalyst mixture were mechanically stirred, after which additions of methanol (Fisher) and 6 molar NH₄OH were made. Tetraethylorthosilicate (TEOS, Sigma) and 3-(trihydroxysilyl)-1-propanesulfonic acid (TPS, Gelest, 30-35% in water) were added drop-wise to achieve desired degrees of sulfonation at a constant total silane concentration of ca. 40%. Following silane addition, the beaker was covered with parafilm wax containing small holes to allow for slow solvent evaporation. The solution was stirred until all visible solvent had evaporated. The samples were placed in a drying oven at 135° C. overnight to remove any remaining solvent. Dried samples were finely ground using a mortar and pestle and placed in a glass vial for storage. If left exposed to air the CCEs absorbed water from the atmosphere. If this occurred, further drying at 135° C. was completed before subsequent materials and half-cell electrochemical characterization.

CCE Spray Deposition

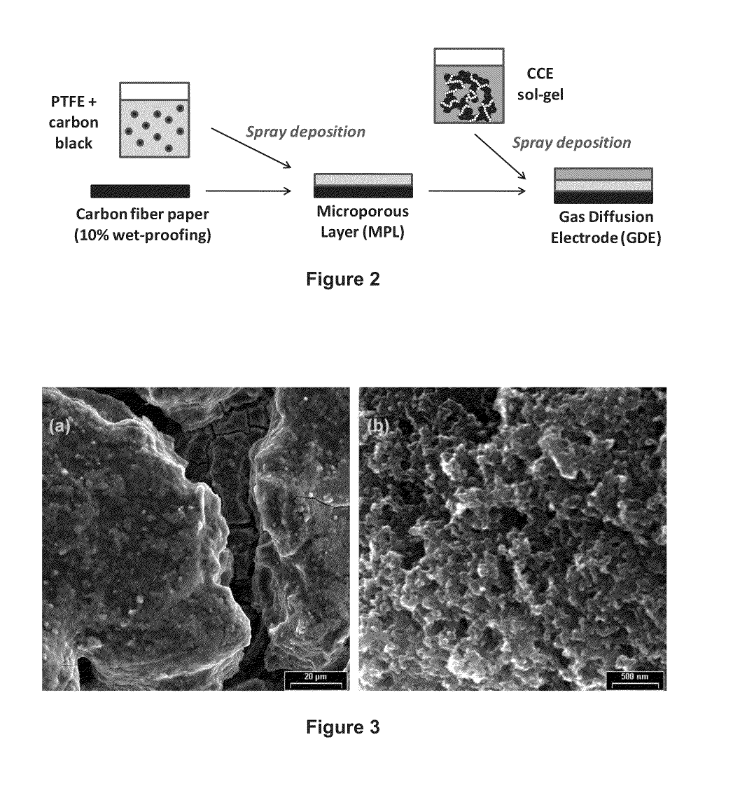

CCE material for spray deposition was fabricated in a manner similar to that described in the previous section. In this case, the CCE was prepared to achieve a 5:95 TPS-to-TEOS mole ratio in the ionomer. The mixture was allowed to gel for 72 hours after which point the partially gelled CCE was spray deposited onto a gas diffusion layer (GDL) using an air brush. The GDL was prepared in-house according to the procedure reported by Qi and Kaufman²⁹, and consisted of carbon fibre paper (Toray TPGH-090, 10 wt % wet-proofing) coated with a Vulcan XC72/Teflon microporous layer (MPL, 2 mg cm⁻² Vulcan carbon, 39 wt % Teflon). A schematic diagram of the CCE deposition process is shown in FIG. 2. Following deposition, the resulting electrodes was dried for 30 min at both room temperature and 135° C. The electrode had a platinum loading of 0.34 mg cm⁻² and a total silicate loading of 40 wt %, and referred to as SS-CCE to distinguish it from the monolith samples.

Materials Characterization

Thermogravimetric analysis (TGA) was performed using a TA Instruments Q600 SDT thermal analyzer. Samples were heated from room temperature to 800° C. at a rate of 20° C. min⁻¹ under flowing air (50 mL min⁻¹). Brunauer-Emmett-Teller (BET) surface areas were collected using a Gemini VII 2390 Series surface area analyzer using the single-point BET method. The CCE containing 4:96 TPS-to-TEOS ratio was analyzed using EDX. Scanning electron microscopy (SEM) images of the CCE layer were acquired using a JOEL JSM 6400 SEM.

Electrochemical Measurements

Half-Cell Measurements

Samples for half-cell electrochemical measurements were prepared as electrode inks immobilized on glassy carbon electrodes³⁰. Inks were fabricated by combining CCE material (20-50 mg) with a 50:50 mixture of isopropyl alcohol and deionized water to give a total volume of 500 μL. The mixture was sonicated for approximately 60 minutes until a thick ink-like material formed, of which 2 μL of CCE ink was deposited using a microsyringe onto a 3 mm diameter glassy carbon working electrode (CH Instruments). The deposit was allowed to dry for 30 minutes in air at room temperature. A platinum loading of 0.15±0.01 mg cm⁻² was achieved for all samples.

Electrochemical experiments were performed in a three-electrode cell constructed with a platinum wire counter electrode and an Ag/AgCl reference electrode (CH Instruments). All measurements were obtained in N₂-purged 0.5 M H₂SO₄ (aq) at room temperature. Electrochemical measurements were collected using a Solatron 1470E Multichannel Potentiostat and a 1260 frequency response analyzer controlled using Multistat software (Scribner Associates). Electrochemical impedance spectra (EIS) were obtained over a frequency range of 100 kHz to 0.1 Hz at a DC bias potential of 0.2 V vs. Ag/AgCl. EIS data was analyzed using a finite transmission-line model^{31, 32}.

Full Cell Measurements

Fuel cell membrane electrode assemblies (MEAs) were fabricated by hot-pressing (150 kg cm⁻² for 90 s at 130° C.) a 5 cm² test electrode (cathode) and a similar-sized commercial anode (ELAT A6STDSIV2.1 Pt loading=0.5 mg cm⁻², proprietary ionomer loading) across a Nafion NRE212 membrane. For comparison, a MEA was prepared using an ELAT electrode as both the test electrode and the anode. MEAs were tested in a 5 cm² test fuel cell (Fuel Cell Technologies). Initial fuel cell testing was performed at cell temperatures between 25° C. and 80° C. with feed gases (H₂ and O₂) humidified at 80° C. and pressurized to 10 psig (170 kPa) at the outlets. Durability testing was performed at cell temperatures of 30° C. and 80° C. with feed gases (H₂ and O₂) humidified at the cell temperature, and at 80° C. the outlets were pressurized to 10 psig. Humidity measurements were performed at a cell temperature and anode temperature of 80° C. with variable temperature at the cathode gas feed. Gases were pressurized to 10 psig at the outlets for humidity testing.

All cyclic voltammetry (CV) and electrochemical impedance spectroscopy (EIS) measurements were collected at the aforementioned temperatures with humidified N₂ flowing at the cathode and with the H₂ electrode serving as both the reference and the counter electrode. All electrochemical measurements were performed using a Solartron 1470E Multichannel Potentiostat and a 1260 frequency response analyzer controlled using Multistat software (Scribner Associates). Impedance spectra were collected over a frequency range of 100 kHz to 0.1 Hz at a DC bias potential of 0.425V.

Materials Characterization

The weight percent composition of the CCE materials was determined by performing TGA under air. Using these conditions, the decomposition of the sulfonic acid group, combustion of the organic side chain, and the carbon black can be resolved which facilitates determination of the weight percent of these components^{21, 33, 34}. TGA indicated that the fully gelled TPS/TEOS monoliths possessed 4-12% sulfonate content with a total silane concentration of ca. 40%. The spray-deposited CCE used for fuel cell testing had an overall silicate content of 40 wt %, of which 6 mol % was TPS (balance TEOS), and 60 wt % platinized carbon.

SEM images for the TPS/TEOS CCE catalyst layer are shown in FIG. 3. FIG. 3(a) indicates that the spray-deposition method produced a homogeneous catalyst layer with morphology typical of fuel cell electrodes. The higher magnification image, FIG. 3(b), illustrates that the CCE layer is homogeneous at the micro/nano-scale with little agglomeration. It can be seen in FIG. 2(b) that the CCE layer clearly has a high degree of micro and meso-porosity.

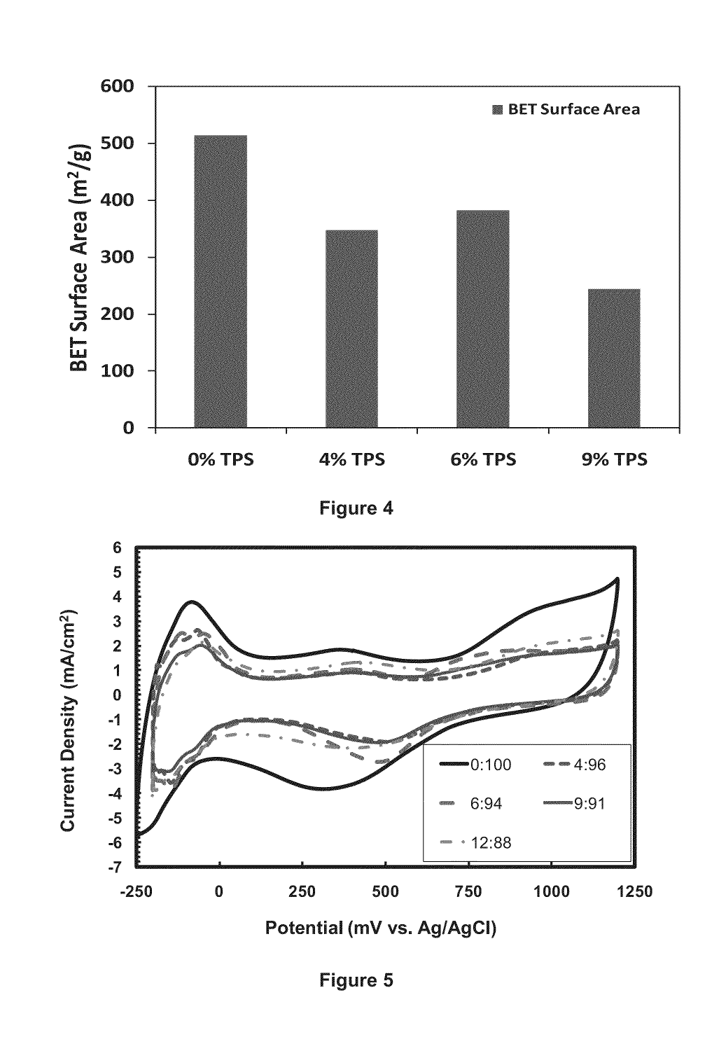

FIG. 4 shows the BET surface area data obtained for TPS/TEOS monoliths using the single-point analysis. These results were compared to the BET surface area of a CCE prepared with the unsulfonated silane TEOS (ca. 45% silane). It has been reported in literature that while Vulcan XC72 has BET surface area of 232 m² g⁻¹, Anderson et al. demonstrated that CCEs consisting of Pt/C—SiO₂ can have BET surface areas over 700 m² g⁻¹²⁰. It should be noted that Anderson et al. used supercritical CO₂ in the drying of their materials which aids in retention of pore structure and likely accounts for the difference in BET surface area compared to materials obtained here. Using the single-point method, the control sample containing 45% TEOS displayed a BET surface area of 514 m² g⁻¹, showing an increase in surface area with the addition of silica to the catalyst material. The TPS/TEOS samples had BET surface areas are in the range of 250-380 m² g⁻¹, which is relatively close to the control 45% TEOS sample. By fabricating the electrode materials to contain small amounts of sulfonated silane, a porous electrode structure with a high surface area were thus obtained. High resolution BET analysis indicated that the 4% TPS CCE had a surface area of 403 m² g⁻¹ while the TEOS control had a surface area of 405 m² g⁻¹. The high resolution analysis suggested that the CCE catalyst layer is a highly porous medium with a surface area that is substantially larger than that of the bare Vulcan carbon surface (250 m²/g, manufacturer's specifications). A comparison of the BET data obtained for the 4% TPS CCE and the control are shown in Table 1.

TABLE 1
Summary of BET data for 4% TPS CCE and 45% TEOS control

| | | 4% TPS |
|---|---|---|
| | 45% TEOS | (40% silane) |
| Single point SA (m² g⁻¹) | 394.86 | 396.57 |
| BET SA (m² g⁻¹) | 404.69 | 403.14 |
| Total pore volume (cm³ g⁻¹) | 0.433 | 0.263 |
| Volume between 17 and 3000 Å (cm³ g⁻¹) | 0.329 | 0.160 |
| Average pore width (Å) | 42.82 | 26.05 |
| Average pore diameter (Å) | 66.76 | 44.18 |
| Median pore width (Å) | 11.02 | 10.60 |

Half-Cell Electrochemical Characterization

FIG. 5 displays the CVs for CCE samples with varying concentrations of TPS/TEOS. The peaks in the hydrogen adsorption and desorption regions, and therefore the resulting electrochemically active surface area (ECSA), were smaller for the TPS/TEOS samples than for the TEOS control. However, these peaks are better resolved for the TPS/TEOS inks as there are two distinct sorption peaks evident as opposed to one large peak for the TEOS control. This indicates that reactions on the platinum sites may be proceeding more efficiently due to the incorporation of sulfonated silane. It is somewhat surprising that the ECSA for the TPS/TEOS samples are similar to the TEOS control when the BET surface areas are lower than the control. It is possible that while roughly the same amount of platinum is being accessed in both sets of samples, the available carbon surface area has been reduced due to TPS filling the carbon micropores.

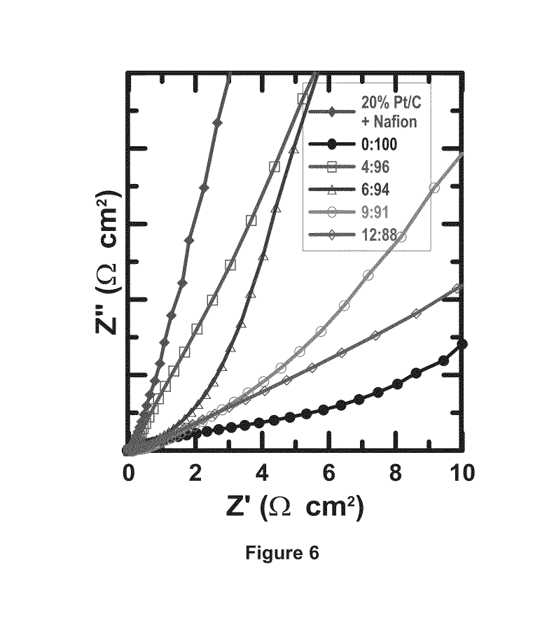

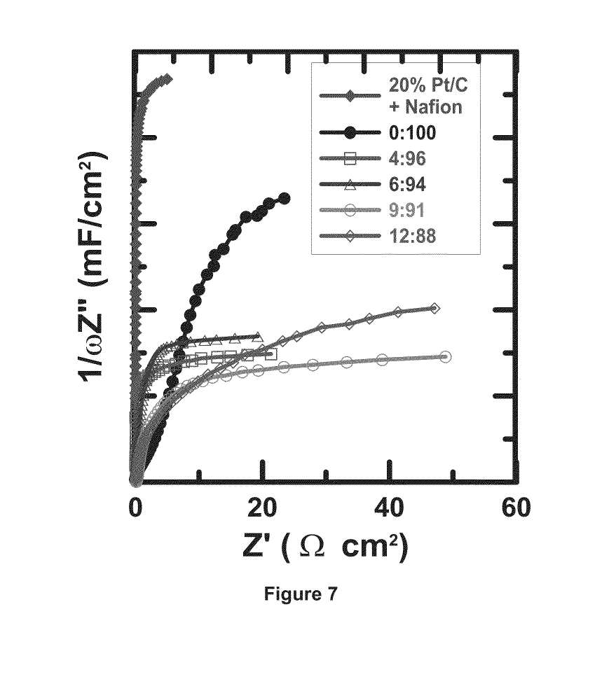

To study the variations in proton conductivity for the different catalyst layers, electrochemical impedance spectroscopy (EIS) was performed. The impedance responses of the TPS/TEOS composite samples were studied as a function of silane content and are shown in FIG. 6 as Nyquist plots. The sulfonated CCE materials were compared to the control TEOS CCE and to a standard catalyst layer composed of Pt/C and Nafion. For composite samples, the plot shows that addition of small amounts of TPS to the predominantly TEOS ionomer mixture greatly decreases the ionic resistance within the catalyst layers. The lowest ionic resistance occurs in the 4% and 6% TPS samples. To better illustrate the variability of proton conduction between catalyst layers, the EIS data was displayed using capacitance plots^{35, 36}. Capacitance plots permit visualization of conductivity in the catalyst layer and active area at once. The steepness of the slope in the high frequency region of the plot indicates proton conductivity, such that a steep slope is indicative of high proton conductivity. Limiting capacitance for each sample is proportional to active area^{32, 35}, therefore a high limiting capacitance signifies that a large portion of the catalyst layer is utilized. FIG. 7 shows capacitance plots for the TPS/TEOS electrodes. The ECSA is similar for all four samples, but is lower than for the TEOS control. This indicates that there is a reduction in capacitance of the CCEs when TPS is added. As capacitance is proportional to active area, trends of capacitance and ECSA would be expected to mimic the trends in the BET analysis. However, ECSA is a representation of available platinum area while capacitance is indicative of carbon area. It appears that composite samples have high BET surface area and similar platinum area to the TEOS control, but the carbon area and thus capacitance are lower. This may be due to TPS filling carbon micropores, which could account for the large decrease in capacitance upon addition of TPS to TEOS without drastic reduction in BET surface area or ECSA. Conversely, proton conductivity is much higher for the TPS/TEOS samples than the TEOS control, and the slope of the 4% TPS sample in the high frequency region is initially comparable to the slope of the standard Nafion electrode.

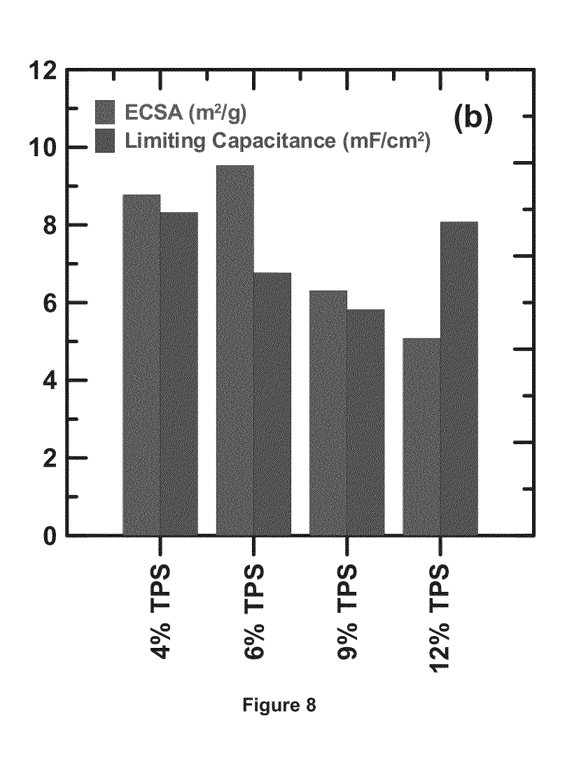

FIG. 8 illustrates the trends in ECSA of Pt (in m² g⁻¹) and the limiting capacitance for the CCE materials. The composite samples exhibit lower ECSAs than that of the TEOS control sample, but proton conductivity appears remarkably improved. When considering all characterization results on CCEs with varied sulfonate concentration, it was determined that the maximum performance was achieved using 4-6% sulfonated silane content. Therefore, to further test the viability of these materials for fuel cell applications an electrode was prepared via direct spray-deposition of a CCE containing 6% TPS onto a GDL+MPL substrate.

Initial Fuel Cell Electrochemical Characterization

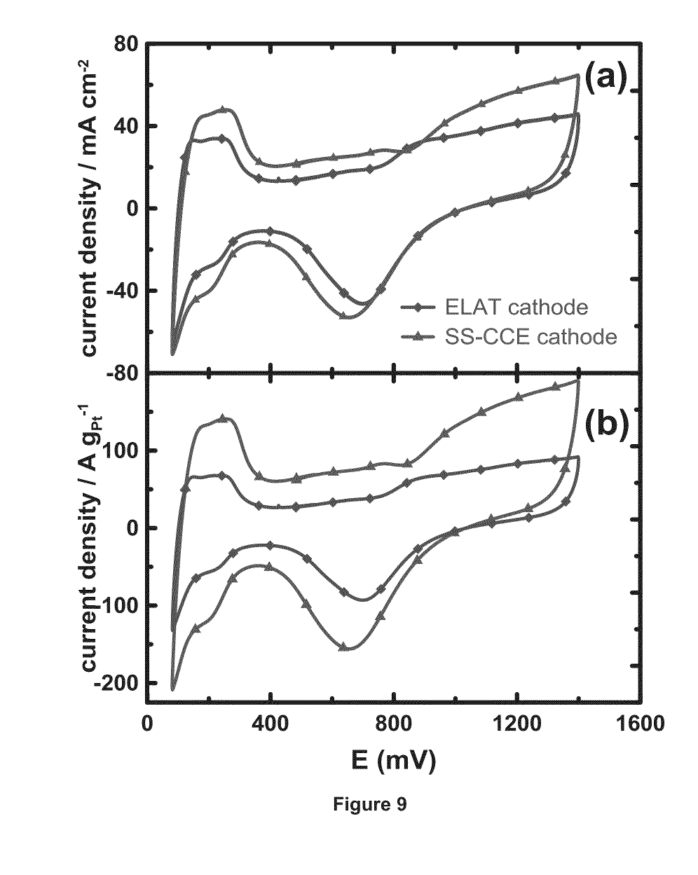

The CVs obtained for the SS-CCE cathode and the ELAT cathode are displayed in FIG. 9. The area under the H_{ads} peaks was used to establish the ECSA of each, which are listed Table 2. Large, well-defined peaks were obtained for the SS-CCE cathode, which are similar in shape to those collected for the Nafion®-based ELAT electrode. These peaks are much more well-defined (and larger) than those obtained for SiO₂-based CCE²¹, indicating that the addition of a small amount of TPS to the SiO₂ network (6 mol %) has a dramatic impact on ECSA. Since both electrodes are prepared from E-Tek 20% Pt on Vulcan XC72 carbon black, which is known to have an average Pt particle diameter of ca. 3 nM^{32, 37}, Pt utilization can also be calculated. The SS-CCE was determined to have a Pt utilization of 72%, which is substantially higher than for the commercial ELAT electrode material (40%). Furthermore, the ECSA of 67 m² g⁻¹ achieved with the CCE is comparable to some of the largest ECSAs reported in the literature for E-Tek 20% Pt/Vulcan catalysts using Nafion®-based ionomers^{16, 38} and substantially larger than those reported for the same electrocatalysts combined with SPEEK-based ionomers^{3, 14, 16}.

TABLE 2
Comparison of BET and ECSA for different catalyst layers

| | | BET | Electrochemi- | % Pt |
|---|---|---|---|---|
| Cathode | Pt loading | Surface | cal Surface | utilization (3 |
| Composition | (mg cm⁻²) | Area (m² g⁻¹) | Area (m² g⁻¹) | nm particles) |
| ELAT, prop. | 0.5 | N.A. | 37 | 40 |
| Nafion | | | | |
| content | | | | |
| SS-CCE | 0.34 | 403.12 | 67 | 72 |
| TEOS CCE | 0.21^{a} | 404.69 | 15^{a} | 16 |

^{a}Data from Ref 21.

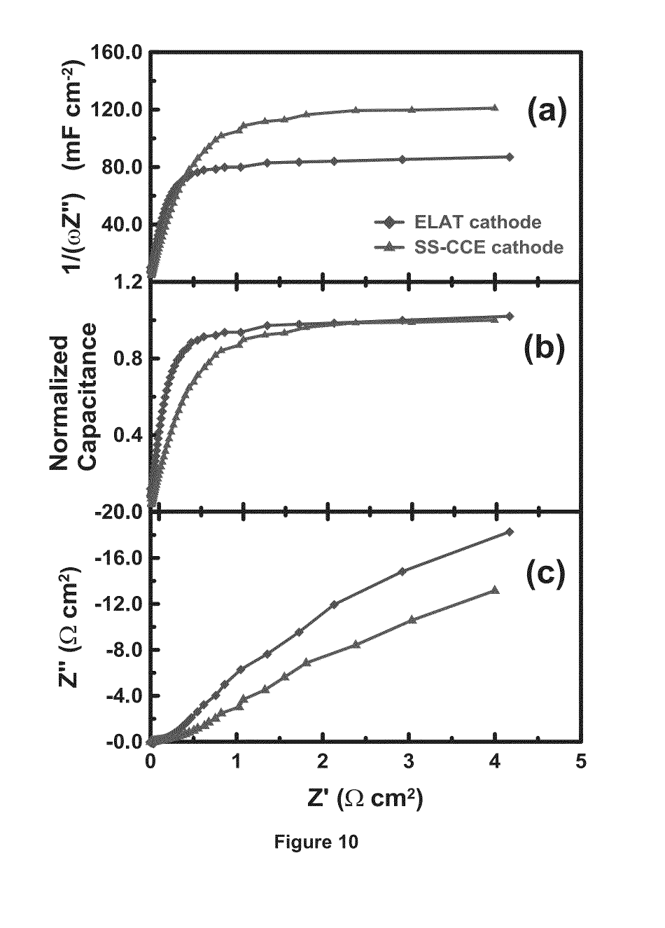

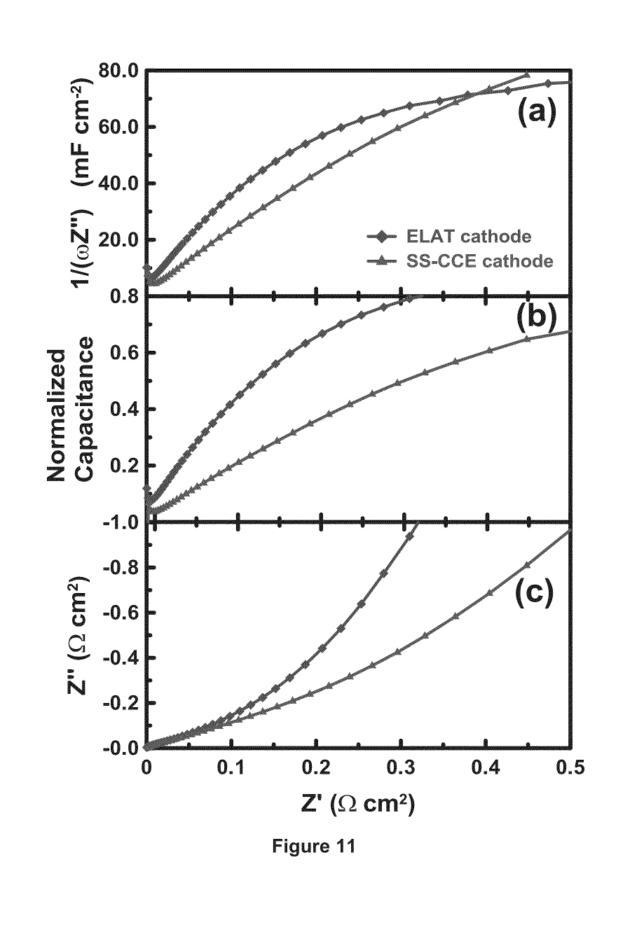

The EIS spectra obtained for the SS-CCE and ELAT cathodes are shown in FIG. 10 as capacitance (FIGS. 10(a) and (b))³⁶ and Nyquist plots (FIG. 9(c)). An expanded view of each plot is shown in FIG. 11. Both electrodes show steep slopes in the high frequency region of the capacitance plot (FIG. 10(a)), indicating comparably high proton conductivity within both types of catalyst layers. The SS-CCE catalyst layer shows a higher limiting capacitance than the ELAT electrode. This may be due to the higher ECSA of the SS-CCE but that cannot be unequivocally stated since the GDL materials used for each are different, thus their contribution to the capacitance cannot be considered equal. Normalized capacitance plots, where capacitance is normalized by dividing by its limiting value, allow comparison of proton conductivity of electrodes with different capacitive areas. FIG. 10(b) displays the comparatively high proton conductivity of both electrodes, though it suggests the proton conductivity in the ELAT electrode is slightly higher.

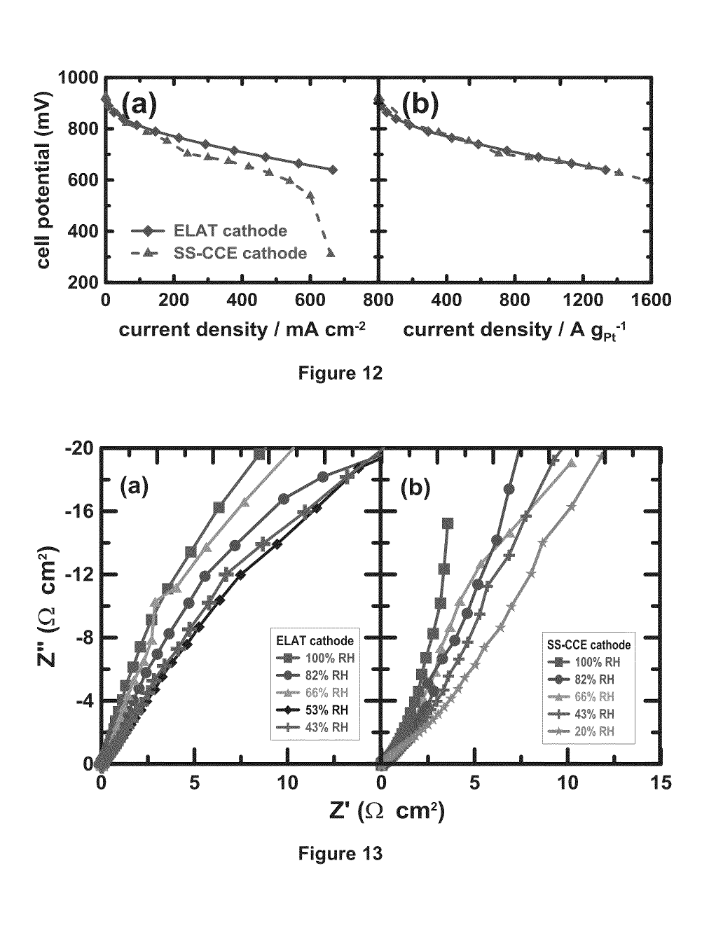

FIG. 12 compares the fuel cell polarization curves gathered for both the SS-CCE and Nafion®-based ELAT cathode. The two MEAs display similar performance, though the Nafion®-based ELAT cathode was superior at high current densities. This can be partially attributed to higher platinum loading in the ELAT electrode, as shown in FIG. 12(b). The performance differences can also be attributed to the hygroscopic nature of the SS-CCE, which leads to significant mass transport limitations at high current densities. The CCE material readily retains water, which makes it more susceptible to flooding in the pores of the catalyst layer. While this can often be a detriment, it suggests that the SS-CCE may have a greater ability to maintain performance under drier cathode conditions than Nafion®-based electrodes. Regardless, the performance of the CCE was remarkable considering the absence of Nafion® in any part of the catalyst layer, and this appears to be one of the highest performing non-Nafion®-based catalyst layers reported to date.

Variable Humidity Fuel Cell Electrochemical Characterization

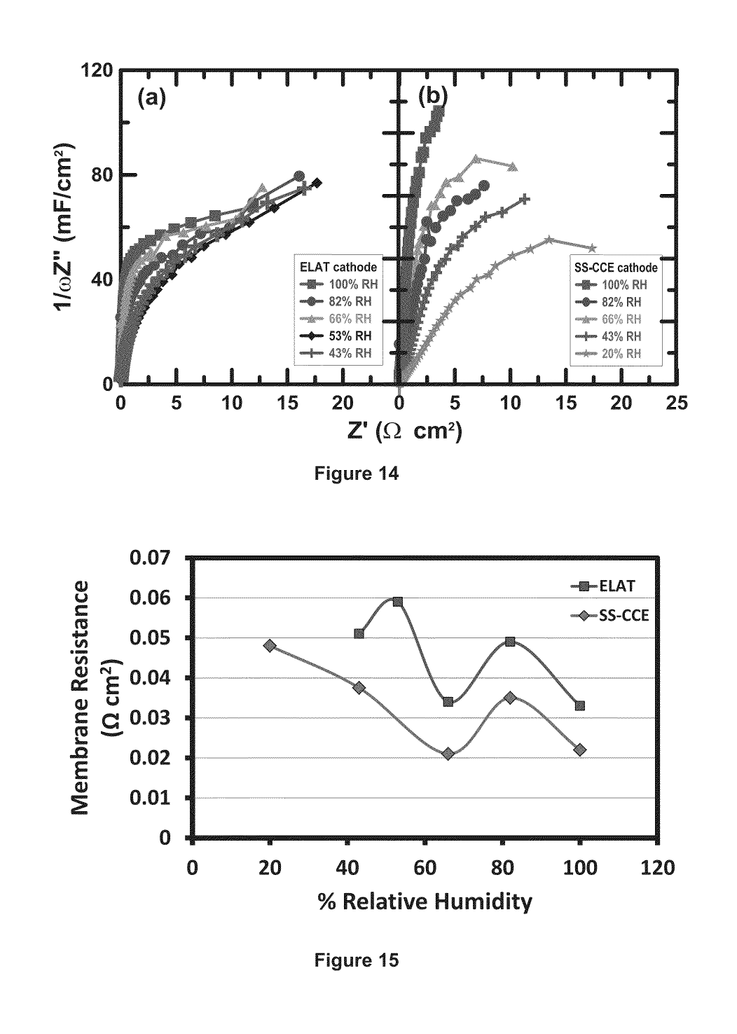

The performance of CCE materials when exposed to multiple cycling and low relative humidity environments was evalutated. Electrochemical measurements with a constant anode and cell temperature of 80° C. and 100% RH but variable relative humidity at the cathode were conducte. Changes in the impedance spectra should be a result of the change in humidity in the cathode catalyst layer. EIS data was analysed using Nyquist plots (FIG. 13). There is a lengthening of the Warburg region as the relative humidity at the cathode decreases, indicating that ionic resistance is increasing. This is evident in both the ELAT cathode and SS-CCE cathode catalyst layers. Ionic conductivity in the layer thus appears to have decreased with reduced water content. The capacitance plots in FIG. 14 show this more prominently, as there is a decrease in the steepness of the initial capacitance curves as relative humidity decreases for both types of electrodes. The ELAT cathodes display a decrease in proton conductivity but little change in the limiting capacitance (active areas) at different % RH. There is also a decrease in proton conductivity for the SS-CCE electrodes, though this is coupled with a decrease in the limiting capacitance as we move to lower relative humidities. Nonetheless, the limiting capacitance at 20% RH is higher than for the fully hydrated Nafion-based catalyst layer.

A noteworthy result of relative humidity testing was the effects of variable humidity in the cathode on the membrane resistance. Water content within the membrane is crucial for proton conduction, and conventional MEA designs employ hygroscopic membranes to aid in water retention (and therefore proton conduction) at high temperatures and low humidities. However, this does not provide hydration to the anode and cathode catalyst layers which results in lower fuel cell performance than can be achieved at 100% RH. Alternatively, our strategy was to utilize hygroscopic materials in the catalyst layer while maintaining a standard membrane, the results of which are shown in FIG. 15. The membrane resistance has only a slight increase as the relative humidity at the cathode is decreased, which indicates that the membrane water content does not largely fluctuate as the water content in the cathode is reduced. The ELAT cathode displays much higher membrane resistance under similar conditions to the SS-CCE cathode. Addition of the water retention material in the electrode appears to maintain electrode activity while simultaneously hydrating the membrane via back diffusion of water.

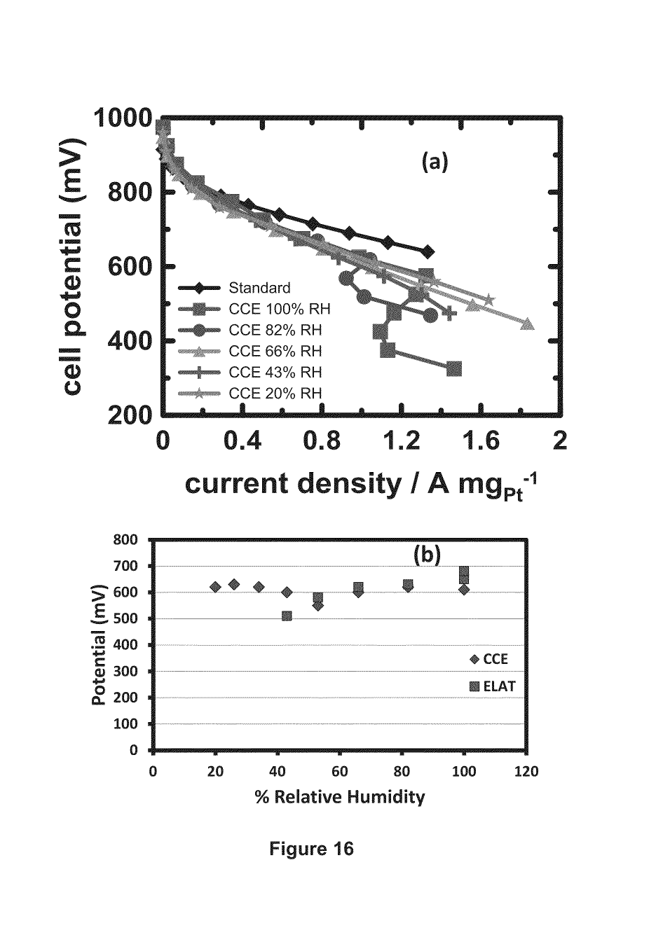

The effect of relative humidity on fuel cell performance for the SS-CCE cathode catalyst layer is shown in FIG. 16 (a). At low current densities, the performance of the Nafion®-based cathode was similar to that of the SS-CCE cathode at all relative humidities. Mass transport limitations are evident at 100% and 82% RH, indicating that a significant amount of flooding is a concern under these temperatures. As the % RH continues to decrease, these mass transport losses are no longer evident and the SS-CCE cathode displays no change in performance down to 20% RH. Nafion®-based systems have significant performance drops when the cathode relative humidity is low, so the retention of performance by the CCE materials is noteworthy. This is significant because it allows the fuel cell to be operated in multiple environments and because low humidity conditions aid in the reduction of the overall balance-of-plant. Power is required to humidify the gases to 100% RH, therefore the reduction in the need to humidify the gases to such specifications reduces the amount of parasitic power required for the fuel cell system.

FIG. 16b shows the potential at 1 A mg_{Pt}⁻¹ for both SS-CCE and ELAT electrodes at different relative humidities. As % RH decreases, there is little fluctuation in the potential for the SS-CCE and the potential at 20% RH is similar to that at 100% RH. Under fully humidified conditions the ELAT cathode has a higher potential than the SS-CCE, but as % RH decreases so does the potential at 1 A mg_{Pt}⁻¹. At about 40% RH the potential for the ELAT cathode is lower than that of the SS-CCE cathode, indicating that with this system it is possible to measure better performance for these electrodes than for commercial electrodes under low humidity conditions. Stable cell performance below 40% RH could not be obtained using ELAT cathodes, indicating these to be unsuitable for operation under these conditions. However, the MEA that employed the exemplified SS-CCE cathode of the invention as able to operate with no loss in performance down to 20% RH. Further tests at RH levels below 20% have yet to be completed but it is expected that there would be no loss in performance.

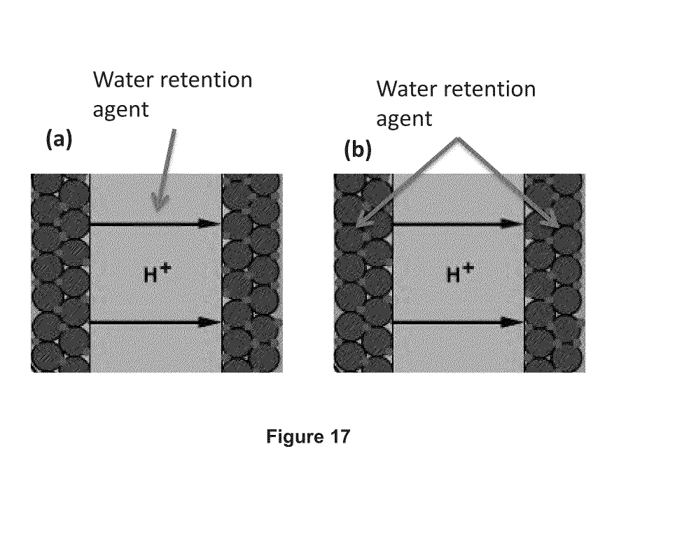

Disclosed embodiments thus establish the feasibility of sulfonated silica-based electrode structures for use in a fuel cell (and other electrochemical devices, such as sensors) that can operate with little or no change in performance over a relatively wide temperature range and relative humidity range. This permits operation of PEM fuel cells at high temperature/low humidification operation. Employment of hygroscopic materials in one or both electrodes and use of a standard membrane material, as illustrated in FIG. 17 should thus be possible. By incorporating water retention agents as part of an electrode layer, activity is maintained within the electrode, but hydration of the membrane through enhanced rates of back diffusion of water may also occur.

The disclosures of all references mentioned herein are incorporated herein by such mention as though those disclosures were reproduced in this specification in their entirety.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

(1) Litster, S.; McLean, G. PEM fuel cell electrodes. J. Power Sources 2004, 130, 61-76.
(2) Passalacqua, E.; Lufrano, F.; Squadrito, G.; Patti, A.; Giorgi, L. Nafion content in the catalyst layer of polymer electrolyte fuel cells: effects on structure and performance. Electrochim. Acta 2001, 46, 799-805.
(3) Peron, J.; Shi, Z.; Holdcroft, S. Hydrocarbon proton conducting polymers for fuel cell catalyst layers. Energy Environ. Sci. 2011, 4, 1575-1591.
(4) Easton, E. B.; Qi, Z. G.; Kaufman, A.; Pickup, P. G. Chemical modification of proton exchange membrane fuel cell catalysts with a sulfonated silane. Electrochem. Solid State Lett. 2001, 4, A59-A61.
(5) Antonio Asensio, J.; Sanchez, E. M.; Gomez-Romero, P. Proton-conducting membranes based on benzimidazole polymers for high-temperature PEM fuel cells. A chemical quest. Chem. Soc. Rev. 2010, 39, 3210-3239.
(6) Pedersen, A. W.; Pauric, A. D.; Eastcott, J. I.; Easton, E. B. Proton Conductivity within Fuel Cell Electrodes Containing a Sulfonated Carbon Support. ECS Transactions 2010, 28, 39-49.
(7) Du, C. Y.; Zhao, T. S.; Liang, Z. X. Sulfonation of carbon-nanotube supported platinum catalysts for polymer electrolyte fuel cells. J. Power Sources 2008, 176, 9-15.
(8) Shao, Y.; Liu, J.; Wang, Y.; Lin, Y. Novel catalyst support materials for PEM fuel cells: current status and future prospects. J. Mater. Chem. 2009, 19, 46-59.
(9) Xu, Z.; Qi, Z.; Kaufman, A. Advanced fuel cell catalysts—Sulfonation of carbon-supported catalysts using 2-aminoethanesulfonic acid. Electrochem. Solid State Lett. 2003, 6, A171-A173.
(10) Xu, Z.; Qi, Z.; Kaufman, A. Modification and improvement of proton-exchange membrane fuel cells via treatment using peracetic acid. J. Power Sources 2003, 115, 49-53.
(11) Xu, Z.; Qi, Z.; Kaufman, A. Superior catalysts for proton exchange membrane fuel cells sulfonation of carbon-supported catalysts using sulfate salts. Electrochem. Solid State Lett. 2005, 8, A313-A315.
(12) Lakshmi, N.; Rajalakshmi, N.; Dhathathreyan, K. Functionalization of various carbons for proton exchange membrane fuel cell electrodes: analysis and characterization. J. Phys. D-Appl. Phys. 2006, 39, 2785-2790.
(13) Sambandam, S.; Ramani, V. SPEEK/functionalized silica composite membranes for polymer electrolyte fuel cells. J. Power Sources 2007, 170, 259-267.
(14) Peron, J.; Edwards, D.; Besson, A.; Shi, Z.; Holdcroft, S. Microstructure-Performance Relationships of sPEEK-Based Catalyst Layers. J. Electrochem. Soc. 2010, 157, B1230-B1236.
(15) Park, J.; Krishnan, P.; Park, S.; Park, G.; Yang, T.; Lee, W.; Kim, C. A study on fabrication of sulfonated poly(ether ether ketone)-based membrane-electrode assemblies for polymer electrolyte membrane fuel cells. J. Power Sources 2008, 178, 642-650.
(16) Astill, T.; Xie, Z.; Shi, Z.; Navessin, T.; Holdcroft, S. Factors Influencing Electrochemical Properties and Performance of Hydrocarbon-Based Electrolyte PEMFC Catalyst Layers. J. Electrochem. Soc. 2009, 156, B499-B508.
(17) Easton, E. B.; Astill, T. D.; Holdcroft, S. Properties of gas diffusion electrodes containing sulfonated poly(ether ether ketone). J. Electrochem. Soc. 2005, 152, A752-A758.
(18) Muldoon, J.; Lin, J.; Wycisk, R.; Takeuchi, N.; Hamaguchi, H.; Saito, T.; Hase, K.; Stewart, F. F.; Pintauro, P. N. High Performance Fuel Cell Operation with a Non-fluorinated Polyphosphazene Electrode Binder. Fuel Cells 2009, 9, 518-521.
(19) von Kraemer, S.; Puchner, M.; Jannasch, P.; Lundblad, A.; Lindbergh, G. Gas diffusion electrodes and membrane electrode assemblies based on a sulfonated polysulfone for high-temperature PEMFC. J. Electrochem. Soc. 2006, 153, A2077-A2084.
(20) Anderson, M. L.; Stroud, R. M.; Rolison, D. R. Enhancing the activity of fuel-cell reactions by designing three-dimensional nanostructured architectures: Catalyst-modified carbon-silica composite aerogels. Nano Lett. 2002, 2, 235-240.
(21) Eastcott, J. I.; Easton, E. B. Electrochemical studies of ceramic carbon electrodes for fuel cell systems: A catalyst layer without sulfonic acid groups. Electrochim. Acta 2009, 54, 3460-3466.
(22) Kim, H.; Kohl, P. A. Sol-gel based silica electrodes for inorganic membrane direct methanol fuel cells. J. Power Sources 2010, 195, 2224-2229.
(23) Rabinovich, L.; Lev, O. Sol-gel derived composite ceramic carbon electrodes. Electroanalysis 2001, 13, 265-275.
(24) Lev, O.; Wu, Z.; Bharathi, S.; Glezer, V.; Modestov, A.; Gun, J.; Rabinovich, L.; Sampath, S. Sol-gel materials in electrochemistry. Chem. Mat. 1997, 9, 2354-2375.
(25) TSIONSKY, M.; GUN, G.; GLEZER, V.; LEV, O. Sol-Gel-Derived Ceramic-Carbon Composite Electrodes—Introduction and Scope of Applications. Anal. Chem. 1994, 66, 1747-1753.
(26) Eastcott, J. I.; Yarrow, K. M.; Pedersen, A. W.; Easton, E. B. Fuel cell electrode structures containing sulfonated organosilane-based proton conductors. J. Power Sources 2012, 197, 102-106.
(27) Velan, V. S.; Velayutham, G.; Hebalkar, N.; Dhathathreyan, K. S. Effect of SiO₂ additives on the PEM fuel cell electrode performance. Int J Hydrogen Energy 2011, 36, 14815-14822.
(28) Eastcott, J. I.; Powell, J. A.; Vreugdenhil, A. J.; Easton, E. B. Electrochemical and Morphological Studies of Ceramic Carbon Electrodes for Fuel Cell Systems. ECS Trans. 2011, 41, 853-864.
(29) Qi, Z. G.; Kaufman, A. Improvement of water management by a microporous sublayer for PEM fuel cells. J. Power Sources 2002, 109, 38-46.
(30) Gojkovic, S. L.; Zecevic, S. K.; Savinell, R. F. O[sub 2] Reduction on an Ink-Type Rotating Disk Electrode Using Pt Supported on High-Area Carbons. J. Electrochem. Soc. 1998, 145, 3713-3720.
(31) Lefebvre, M. C.; Martin, R. B.; Pickup, P. G. Characterization of ionic conductivity profiles within proton exchange membrane fuel cell gas diffusion electrodes by impedance spectroscopy. Electrochem. Solid State Lett. 1999, 2, 259-261.
(32) Easton, E. B.; Pickup, P. G. An electrochemical impedance spectroscopy study of fuel cell electrodes. Electrochim. Acta 2005, 50, 2469-2474.
(33) Ranganathan, S.; Easton, E. B. Ceramic carbon electrode-based anodes for use in the Cu—Cl thermochemical cycle. Int J Hydrogen Energy 2010, 35, 4871-4876.
(34) De Almeida, N. E.; Easton, E. B. Nafion/Sulfonated Silica Composite Membranes for PEM Fuel Cells. ECS Transactions 2010, 28, 29-38.
(35) Jia, N. Y.; Martin, R. B.; Qi, Z. G.; Lefebvre, M. C.; Pickup, P. G. Modification of carbon supported catalysts to improve performance in gas diffusion electrodes. Electrochim. Acta 2001, 46, 2863-2869.
(36) Ren, X. M.; Pickup, P. G. Simulation and analysis of the impedance behaviour of electroactive layers with non-uniform conductivity and capacitance profiles. Electrochim. Acta 2001, 46, 4177-4183.
(37) Maillard, F.; Martin, M.; Gloaguen, F.; Leger, J. Oxygen electroreduction on carbon-supported platinum catalysts. Particle-size effect on the tolerance to methanol competition. Electrochim. Acta 2002, 47, 3431-3440.
(38) Gasteiger, H.; Kocha, S.; Sompalli, B.; Wagner, F. Activity benchmarks and requirements for Pt, Pt-alloy, and non-Pt oxygen reduction catalysts for PEMFCs. Appl. Catal. B-Environ. 2005, 56, 9-35.
(39) Selvaganesh, S. V.; Selvarani, G.; Sridhar, P.; Pitchumani, S.; Shukla, A. K. A Durable PEFC with Carbon-Supported Pt—TiO2 Cathode: A Cause and Effect Study. J. Electrochem. Soc. 2010, 157, B1000-B1007.

What is claimed is:

1. A method of making a composite electrode catalyst layer, the method comprising:
(i) forming a sol-gel by at least partially polymerizing first and second precursors of an ionomer, the first precursor being a sulfonated organosilane, in the presence of a carbon-supported catalyst; and
(ii) applying the sol-gel to a substrate.

2. The method of claim 1, wherein the sulfonated organosilane has the structure shown by formula (I): 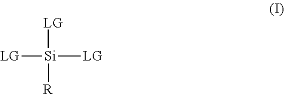
wherein:
R is sulfanylalkyl, sulfanylaryl, sulfanylalkylaryl, sulfanylarylalkyl or sulfanylalkylarylalkyl; and
each LG is a leaving group.

3. The method of claim 2, wherein: each LG is independently selected from the group consisting of alkoxy, Cl, Br, hydroxy, aryloxy, arylalkoxy, and alkylaryloxy; R is sulfanyl alkyl; and the first and second precursors are selected to form a sulfonated silica ionomer in said polymerizing.

4. The method of claim 1, wherein the second precursor has the structure shown by formula (II): 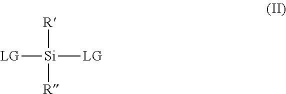
wherein:
each LG is a leaving group; and
each of R′ and R″ is, independently of the other, a leaving group or optionally substituted alkyl, optionally substituted alkenyl, optionally substituted aryl, optionally substituted arylalkyl, optionally substituted alkylaryl, wherein the optional substituents are independently selected from the group consisting of F, hydroxy and methyl.

5. The method of claim 4, wherein each leaving group is selected from the group consisting of alkoxy, Cl, Br, hydroxy, aryloxy, arylalkoxy, and alkylaryloxy, and wherein each of R′ and R″ is a leaving group.

6. The method of claim 1, wherein the sulfonated organosilane has the structure shown by formula (I): 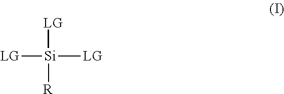
wherein:
R is sulfanylalkyl, sulfanylaryl, sulfanylalkylaryl, sulfanylarylalkyl or sulfanylalkylarylalkyl; and
each LG is a leaving group; and
wherein the second precursor has the structure shown by formula (II): 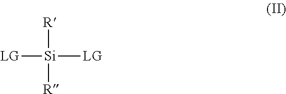
wherein:
each LG is a leaving group; and
each of R′ and R″ is, independently of the other, a leaving group or optionally substituted alkyl, optionally substituted alkenyl, optionally substituted aryl, optionally substituted arylalkyl, optionally substituted alkylaryl, wherein the optional substituents are independently selected from the group consisting of F and methyl.

7. The method of claim 6, wherein: each LG is independently selected from the group consisting of alkoxy, Cl, Br, hydroxy, aryloxy, arylalkoxy, and alkylaryloxy; R is sulfanyl alkyl; each of R′ and R″ is a leaving group selected from the group consisting of alkoxy, aryloxy, arylalkoxy, and alkylaryloxy, and wherein step (i) includes forming a mixture of said first and second precursors and the carbon-supported catalyst in the presence of a base which catalyzes said polymerizing, and said mixture further comprises water and a lower alcohol.

8. The method of claim 7, further comprising the step of drying the sol-gel, subsequent to step (ii), to remove solvent therefrom and forming the sol-gel includes mixing the first and second precursors and carbon-supported catalyst such that the carbon-supported catalyst becomes embedded in the matrix of the ionomer during the at least partially polymerizing step.

9. A method of forming a catalyst layer of a composite electrode, comprising: coating a substrate with a sol-gel composition comprising the reaction product of first and second precursors of an ionomer, the first precursor being a sulfonated organosilane, and a carbon-supported catalyst; and drying the coated substrate to remove solvent of the composition and form the catalyst layer.

10. The method of claim 9, wherein the sulfonated organosilane has the structure shown by formula (I): 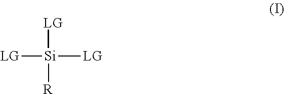
wherein:
R is sulfanylalkyl, sulfanylaryl, sulfanylalkylaryl, sulfanylarylalkyl or sulfanylalkylarylalkyl;
each LG is a leaving group independently selected from the group consisting of alkoxy, Cl, Br, hydroxy, aryloxy, arylalkoxy, and alkylaryloxy; and
the reaction product of the first and second precursors is a sulfonated silica ionomer.

11. The method of claim 9, wherein the second precursor has the structure shown by formula (II): 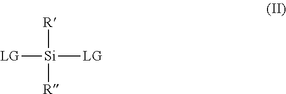
wherein:
each LG is a leaving group; and
each of R′ and R″ is, independently of the other, a leaving group or optionally substituted alkyl, optionally substituted alkenyl, optionally substituted aryl, optionally substituted arylalkyl, optionally substituted alkylaryl, wherein the optional substituents are independently selected from the group consisting of F and methyl.

12. The method of claim 11, wherein each leaving group is selected from the group consisting of alkoxy, Cl, Br, hydroxy, aryloxy, arylalkoxy, and alkylaryloxy, and each of R′ and R″ is a leaving group selected from the group consisting of alkoxy, aryloxy, arylalkoxy, and alkylaryloxy.

13. The method of claim 9, wherein the sulfonated organosilane has the structure shown by formula (I): 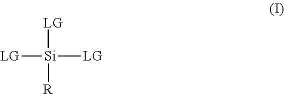
wherein:
R is sulfanylalkyl, sulfanylaryl, sulfanylalkylaryl, sulfanylarylalkyl or sulfanylalkylarylalkyl; and
each LG is a leaving group; and
wherein the second precursor has the structure shown by formula (II): 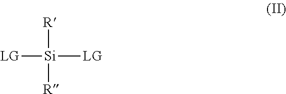
wherein:
each LG is a leaving group; and
each of R′ and R″ is, independently of the other, a leaving group or optionally substituted alkyl, optionally substituted alkenyl, optionally substituted aryl, optionally substituted arylalkyl, optionally substituted alkylaryl, wherein the optional substituents are independently selected from the group consisting of F and methyl.

14. The method of claim 13, wherein: each LG is independently selected from the group consisting of alkoxy, Cl, Br, hydroxy, aryloxy, arylalkoxy, and alkylaryloxy; in the first precursor; and each of R′ and R″ is a leaving group is selected from the group consisting of alkoxy, aryloxy, arylalkoxy, and alkylaryloxy, and further comprising forming the sol-gel composition by admixing said first and second precursors, water, a lower alcohol and the carbon-supported catalyst in the presence of a base prior to coating the substrate.

15. The method of claim 1, wherein the relative amounts of the first and second precursors are selected to obtain an ionomer in which the ratio of sulfonated:unsulfonated polymer units is between 0.02 and 0.4, the catalyst comprises one or more of platinum, ruthenium, cobalt, nickel, iron, manganese and irdium, and the substrate comprises a proton exchange membrane.

16. The method of claim 15, wherein the proton exchange membrane comprises a material selected from the group consisting of Nafion®, sulfonated hydrocarbon-based membranes including sulfonated poly(ether ether ketone) (SPEEK), composite containing one or more inorganic components, including Nafion/SiO₂, SPEEK/SiO₂, and sulfonated siloxanes comprising the structure of formula (A): 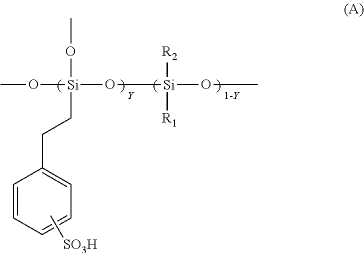
wherein R₁ and R₂ are substituent groups, and 0≦Y≦1, wherein the substrate comprises a microporous layer and a gas diffusion layer directly bonded to the microporous layer.

17. A composite material comprising an ionomer and carbon-supported catalyst, wherein the carbon-supported catalyst is embedded in the matrix of the ionomer and the ionomer comprises the reaction product of a sulfonated organosilane and a silica precursor.

18. The composite material of claim 17, wherein the ionomer is the reaction product of a sulfonated organosilane having the structure shown by formula (I): 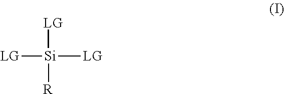
wherein:
R is sulfanylalkyl, sulfanylaryl, sulfanylalkylaryl, sulfanylarylalkyl or sulfanylalkylarylalkyl; and
each LG is a leaving group; and
the silica precursor having the structure shown by formula (II): 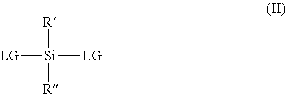
wherein:
each LG is a leaving group; and
each of R′ and R″ is, independently of the other, a leaving group or optionally substituted alkyl, optionally substituted alkenyl, optionally substituted aryl, optionally substituted arylalkyl, optionally substituted alkylaryl, wherein the optional substituents are independently selected from the group consisting of F, hydroxyl and methyl.

19. The composite material of claim 17, wherein the ionomer comprises the structure shown by formula (III): 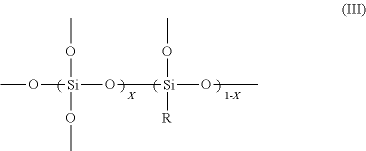
wherein R is sulfanylalkyl, sulfanylaryl, sulfanylalkylaryl, sulfanylarylalkyl or sulfanylalkylarylalkyl; and
0≦X≦1 and (1−X)/X is between 0.05 and 0.1.

20. The composite material of claim 19, wherein R is selected from the group consisting of:

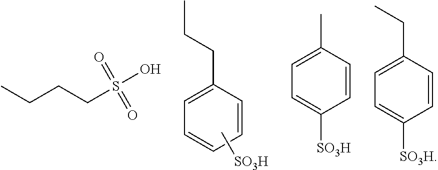

21. The composite material of claim 20 where R is —CH₂CH₂CH₂SO₃H, each of R′ and R″ is selected, independently of the other, from the group consisting of methyl, ethyl, vinyl (H₂C═CH—), propyl, CF₃CH₂CH₂—, PhCH₂CH₂— (Ph=phenyl), benzyl, and phenyl, the catalyst comprises one or more of platinum, ruthenium, cobalt, nickel, iron, manganese and iridium, and the material is substantially free of Nafion®.
